(19) United States
(12) Patent Application Publication
(10) Pub. No.: US 2007/0015484 A1
(43) Pub. Date: Jan. 18, 2007

(54) Apparatus and method for transmitting signals in a communication system

(75) Inventors: Ju-Young Jung, Seongnam-si (KR); Jai-Dong Kim, Yongin-si (KR); Jin-Won Seo, Seoul (KR); Yun-Sang Park, Suwon-si (KR)

Correspondence Address: DILWORTH & BARRESE, LLP, 333 EARLE OVINGTON BLVD., UNIONDALE, NY, 11553, US

(73) Assignee: Samsung Electronics Co., Ltd., Suwon-si (KR)

(21) Appl. No.: 11/487,199

(22) Filed: Jul. 14, 2006

(30) Foreign Application Priority Data
Jul. 14, 2005 (KR) 63679/2005

(51) Int. Cl. H04B 1/16; H04B 1/38

(52) U.S. Cl. 455/343.1; 455/574

(57) ABSTRACT

An apparatus and method is provided for transmitting a signal in a communication system. Upon transition to a power saving mode, a lower layer unit sends a notification indicating the transition to the power saving mode to an upper layer unit. Upon receipt of the notification indicating the transition, the upper layer unit activates a traffic filter having a filtering condition. If upper layer traffic is generated after activating the traffic filter, the upper layer unit filters the upper layer traffic using the traffic filter, and processes the upper layer traffic according to the filtering result.

### PRIORITY

This application claims the benefit under 35 U.S.C. § 119(a) of an application entitled “Apparatus and Method for Transmitting Signals in a Communication System” filed in the Korean Intellectual Property Office on Jul. 14, 2005 and assigned Serial No. 2005-63679, the contents of which are incorporated herein by reference.

### BACKGROUND OF THE INVENTION

1. Field of the Invention

The present invention relates generally to a communication system, and in particular, to an apparatus and method for transmitting signals in a communication system.

2. Description of the Related Art

Generally, the next generation communication system is evolving into a system for providing service capable of high-speed, high-capacity data transmission/reception to subscriber stations (SSs). Particularly, in order to provide service capable of high-speed, high-capacity data transmission/reception to the SSs, the next generation communication system positively considers using an Internet Protocol (IP) scheme. A wireless portable Internet scheme is one of the typical IP schemes. With reference to FIG. 1, a description will now be made of a configuration of a communication system using the wireless portable Internet scheme (hereinafter, “wireless portable Internet communication system”).

FIG. 1 is a diagram illustrating a configuration of a general wireless portable Internet communication system.

Referring to FIG. 1, the wireless portable Internet communication system includes an SS 10, a base station (BS) 20, a backbone network 30, and an Authentication and Service Authorization (ASA) server 40. The SS 10 generally has mobility, and is connected to the backbone network 30 via the BS 20. The ASA server 40 performs authentication and service authorization for the SS 10.

In the wireless portable Internet communication system, because the SS has mobility, power consumption of the SS serves as an important factor that affects the overall performance of the wireless portable Internet communication system. Therefore, several schemes for minimizing the power consumption of the SS have been proposed. A power saving mode scheme is one of the typical proposed schemes. The power saving mode scheme supports a sleep mode and an idle mode. In the sleep mode or the idle mode, the SS stops all processes, for example, a signal transmission process and a signal reception process, except for the processes related to Real Time Clock (RTC) and Phase Locked Loop (PLL).

However, a characteristic of the traffic generated in the wireless portable Internet communication system is different from the characteristic of the traffic generated in the general communication system. That is, compared with the traffic generated in the general communication system, the traffic generated in the wireless portable Internet communication system has burst characteristics, because the traffic is based on the IP scheme.

However, the currently proposed power saving mode scheme is low in efficiency in terms of a reduction in the power consumption of the SS, as it never takes into account burst traffic characteristics of the wireless portable Internet communication system. Accordingly, there is a need for a signal transmission scheme for minimizing the power consumption of the SS taking into account burst traffic characteristics in the wireless portable Internet communication system.

### SUMMARY OF THE INVENTION

It is, therefore, an object of the present invention to provide an apparatus and method for transmitting signals so as to minimize power consumption of an SS in a communication system.

It is another object of the present invention to provide an apparatus and method for transmitting signals taking into account traffic characteristics in a communication system.

According to one aspect of the present invention, there is provided a method for transmitting a signal in a communication system. The method includes, if traffic is generated in a power saving mode, determining whether the traffic has a need for transition from the power saving mode to a normal mode; if the traffic has a need for the transition, transitioning from the power saving mode to the normal mode; and transmitting the traffic to a corresponding destination in the normal mode.

According to another aspect of the present invention, there is provided a method for transmitting a signal in a communication system. The method includes, upon transition to a power saving mode, sending, by a lower layer unit, a notification indicating the transition to the power saving mode to an upper layer unit; upon receipt of the notification indicating the transition, activating, by the upper layer unit, a traffic filter having a filtering condition; if an upper layer traffic is generated after activating the traffic filter, filtering, by the upper layer unit, the upper layer traffic using the traffic filter; and processing, by the upper layer unit, the upper layer traffic according to the filtering result.

According to further another aspect of the present invention, there is provided an apparatus for transmitting a signal in a communication system. The apparatus includes a subscriber station which, if traffic is generated in a power saving mode, determines whether the traffic has need for transition from the power saving mode to a normal mode; which if the traffic has need for the transition, transitions from the power saving mode to the normal mode; and which transmits the traffic to a corresponding destination in the normal mode.

According to yet another aspect of the present invention, there is provided an apparatus for transmitting a signal in a communication system. The apparatus includes a lower layer unit for, upon transition to a power saving mode, sending a notification indicating the transition to the power saving mode to an upper layer unit; the upper layer unit for, upon receipt of the notification indicating the transition from the lower layer unit, activating a traffic filter having a filtering condition, filtering, if an upper layer traffic is generated, the upper layer traffic using the traffic filter, and processing the upper layer traffic according to the filtering result.

### BRIEF DESCRIPTION OF THE DRAWINGS

The above and other objects, features and advantages of the present invention will become more apparent from the following detailed description when taken in conjunction with the accompanying drawings in which:

FIG. 1 is a diagram illustrating a configuration of a general wireless portable Internet communication system;

FIG. 2 is a diagram illustrating an internal structure of an SS in a wireless portable Internet communication system according to the present invention;

FIG. 3 is a diagram illustrating a structure of a traffic filter including n rules; and

FIG. 4 is a signaling diagram illustrating an operation of the SS shown in FIG. 2.

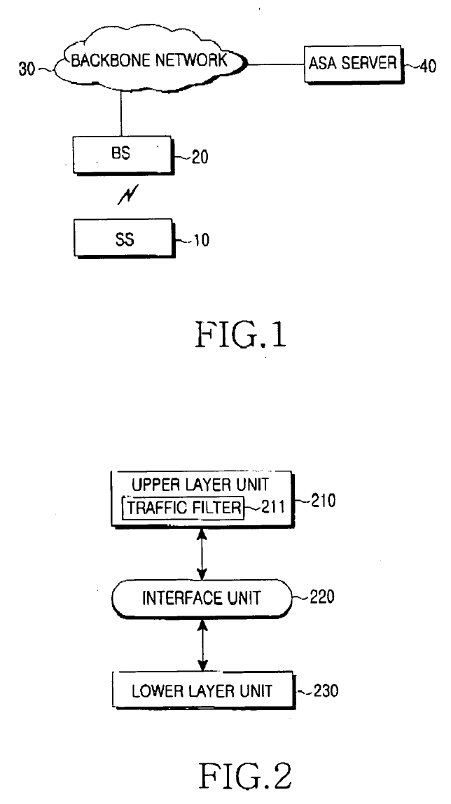

### DETAILED DESCRIPTION OF PREFERRED EMBODIMENTS

Preferred embodiments of the present invention will now be described in detail with reference to the annexed drawings. In the following description, a detailed description of known functions and configurations incorporated herein has been omitted for clarity and conciseness.

The present invention provides an apparatus and method for transmitting signals taking traffic characteristics into account so as to minimize power consumption of a subscriber station (SS) in a communication system, for example, a wireless portable Internet communication system. Although the present invention will be described with reference to the wireless portable Internet communication system for convenience, the signal transmission apparatus and method of the present invention can also be applied to other communication systems in addition to the wireless portable Internet communication system.

FIG. 2 is a diagram illustrating an internal structure of an SS in a wireless portable Internet communication system according to the present invention.

Referring to FIG. 2, the SS includes an upper layer unit 210, an interface unit 220, and a lower layer unit 230, and the upper layer unit 210 includes a traffic filter 211.

The upper layer unit 210 includes a Transmission Control Procedure (TCP)/Internet Protocol (IP) stack and various application programs. For example, the application programs include a computer virus scan program, an instant messaging program, etc.

The traffic filter 211 filters traffic generated in the upper layer unit 210 according to a predetermined filtering condition. For convenience, traffic generated in the upper layer unit 210 will be referred to as “upper layer traffic.” The traffic filter 211 is activated only when the SS is in a power saving mode, i.e. when the lower layer unit 230 is in the power saving mode. The filtering condition of the traffic filter 211 will be described in detail hereinbelow.

The lower layer unit 230 supports an operation in a physical layer and a Medium Access Control (MAC) layer of the wireless portable Internet communication system. The interface unit 220 performs interfacing between the upper layer unit 210 and the lower layer unit 230.

A detailed description will now be made of an operation of the traffic filter 211.

As described above, the traffic filter 211 is activated only when the SS is in the power saving mode. That is, if the SS transitions to the power saving mode, the lower layer unit 230 sends to the upper layer unit 210 a notification indicating the transition of the SS to the power saving mode. Upon receipt of the notification indicating the transition of the SS to the power saving mode from the lower layer unit 230, the upper layer unit 210 activates the traffic filter 211.

After the traffic filter 211 is activated, if upper layer traffic is generated, the upper layer unit 210 filters the upper layer traffic using the traffic filter 211 according to a predetermined filtering condition. The filtering condition is provided for determining whether the upper layer traffic has a need for transition from the power saving mode to a normal mode for the lower layer unit 230. The “normal node” refers to a mode in which normal traffic transmission/reception is possible via the SS. That is, if the upper layer traffic meet the filtering condition, it indicates that the upper layer traffic has a need for transition from the power saving mode to the normal mode. On the contrary, if the upper layer traffic does not meet the filtering condition, it indicates that the upper layer traffic has no need for transition from the power saving mode to the normal mode.

As a result, if the upper layer traffics meet the filtering condition, the upper layer unit 210 delivers the upper layer traffic to the lower layer unit 230 via the interface unit 220. The lower layer unit 230, upon receipt of the upper layer traffic via the interface unit 220, transitions from the power saving mode to the normal mode, and transmits the provided upper layer traffic to a corresponding destination. The operation of allowing the lower layer unit 230 to transmit the upper layer traffics to an actual destination is not directly related to the present invention, so a detailed description thereof will be omitted herein. However, if the upper layer traffics do not meet the filtering condition, the upper layer unit 210 drops (or discards) the upper layer traffics.

The filtering condition can be defined as a rule, and the traffic filter 211 includes at least one rule. The rule includes at least one tuple, and an action defining an operation performed when the tuple is satisfied.

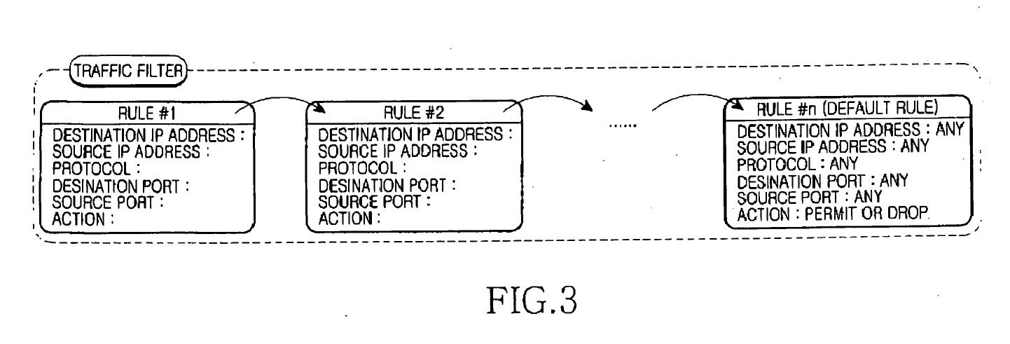

With reference to FIG. 3, a description will now be made of a structure of the traffic filter 211 including a plurality of, for example, n rules.

FIG. 3 is a diagram illustrating a structure of a traffic filter 211 including n rules.

As illustrated in FIG. 3, the traffic filter 211 includes n rules of rule#l to rule#n, and the rule#n is set as a default rule. That is, the upper layer unit 210 filters the upper layer traffics through the rule#l to rule#(n−1) of the traffic filter 211. If the upper layer traffics fails to satisfy all of the rule#14 to rule#(n−1) as a result of the filtering, the upper layer unit 210 uses the default rule rule#n to determine whether to deliver the upper layer traffics to the lower layer unit 230 via the interface unit 220, or to drop the upper layer traffics.

It is assumed that each of the n rules includes a plurality of, for example, 5 tuples. As illustrated in FIG. 3, each of the n rules includes Destination IP Address, Source IP Address, Protocol, Destination Port and Source Port, as its tuple. A description will now be made of each tuple.

First, Destination IP Address indicates an IP address of a destination to which the SS desires to transmit the upper layer traffics. Therefore, if a destination to which the SS desires to transmit the upper layer traffics is different, an IP of the destination is different.

Second, Source IP Address indicates an IP address of a Terminal Equipment (TE) connected to the interface unit 220. If the interface unit 220 is connected to a plurality of TEs, each of the TEs has a different source IP address.

Third, Protocol indicates a protocol used for corresponding upper layer traffics.

Fourth, Destination Port indicates a port of a destination to which the SS desires to transmit the upper layer traffics. If a destination to which the SS desires to transmit the upper layer traffics is different, a port of the destination is different. Herein, even though Destination IP Address is identical, its Destination Port may be different, and this will be described in detail hereinbelow.

It will be assumed that there are upper layer traffics generated in different application programs, for examples, there are upper layer traffics generated in an instant messaging application program and upper layer traffics generated in a computer virus scan application program. If an IP address of the server to be accessed by the instant messaging application program is identical to an IP address of the server to be accessed by the computer virus scan application program, Destination IP Address of the upper layer traffics generated in the instant messaging application program is identical to Destination IP Address of the upper layer traffics generated in the computer virus scan application program. However, because only the server to be accessed is identical and the application programs are different, Destination Port of the upper layer traffics generated in the instant messaging application program is different from Destination Port of the upper layer traffics generated in the computer virus scan application program.

Fifth, Source Port will be described below.

If the same TE processes the upper layer traffics generated in a plurality of application programs, the upper layer traffics, even though they are processed in the same TE, differ in Source Port according to application program. That is, the application programs processed in the same TE have a unique Source Port for their upper layer traffics. As a result, the Source IP Address is a tuple set for filtering in an IP layer, and the Source Port is a tuple set for filtering in User Datagram Protocol (UDP) and Transmission Control Protocol (TCP) layers.

The default rule will now be described in detail hereinbelow.

As illustrated in FIG. 3, the default rule is set regardless of its tuple values so that any upper layer traffic may meet the filtering condition. Simply, the default rule is set such that its action indicates transmission permission for the upper layer traffics, or indicates drop (or discard) of the upper layer traffics. As a result, even though the traffic filter 211 has filtered the upper layer traffics using the rule#l to rule#(n−1), if there is no rule meeting the filtering condition, the upper layer unit 210 filters the upper layer traffic using the default rule rule#n. Because the rule#n meets the filtering condition for any upper layer traffic, the upper layer unit 210 processes the upper layer traffics according to an action included in the rule#n.

As described above, if there are upper layer traffics, the upper layer unit 210 filters the upper layer traffics using the traffic filter 211. That is, if the upper layer traffics filtered using the traffic filter 211 meet the tuples included in the corresponding rule of the traffic filter 211, the upper layer unit 210 performs an operation corresponding to the action included in the corresponding rule. For example, if the action indicates transmission permission for the upper layer traffics, the upper layer unit 210 delivers the upper layer traffics to the lower layer unit 230 via the interface unit 220. On the contrary, if the action indicates drop of the upper layer traffic, the upper layer unit 210 drops the upper layer traffics. Herein, the upper layer unit 210 inactivates the traffic filter 211 as it delivers the upper layer traffic to the lower layer unit 230 via the interface unit 220.

The lower layer unit 230, upon receipt of the upper layer traffics via the interface unit 220, transitions from the power saving mode to the normal mode, and transmits the received upper layer traffics to a corresponding destination.

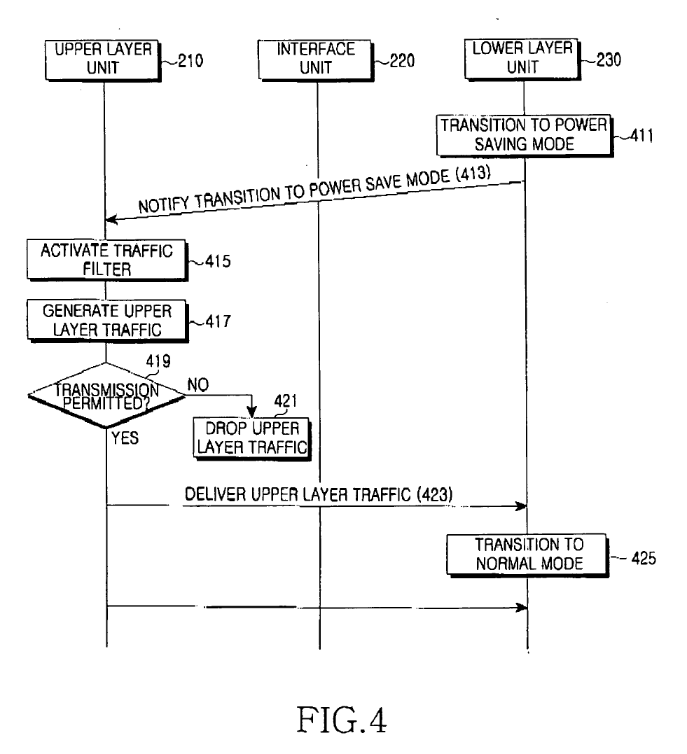

With reference to FIG. 4, a description will now be made of an operation of the SS shown in FIG. 2.

FIG. 4 is a signaling diagram illustrating an operation of the SS shown in FIG. 2.

Referring to FIG. 4, after transitioning to the power saving mode in step 411, a lower layer unit 230 sends a notification indicating the transition to the power saving mode to an upper layer unit 210 in step 413. Upon receipt of the notification indicating the transition to the power saving mode, the upper layer unit 210 activates a traffic filter 211 in step 415. After activating the traffic filter 211, if upper layer traffics are generated in step 417, the upper layer unit 210 determines in step 419 whether to permit transmission of the upper layer traffics by filtering the upper layer traffics using the traffic filter 211. If the upper layer unit 210 determines not to permit transmission of the upper layer traffics, it drops the upper layer traffic in step 421. If the upper layer unit 210 determines to permit transmission of the upper layer traffics, it delivers the upper layer traffics to the lower layer unit 230 in step 423. Upon receipt of the upper layer traffics, the lower layer unit 230 transitions to the normal mode, and transmits the received upper layer traffics to a corresponding node in step 425.

As can be understood from the foregoing description, the present invention transmits signals taking traffic characteristics into account in the wireless portable Internet communication system, contributing to minimization in power consumption of the SS.

While the invention has been shown and described with reference to a certain preferred embodiment thereof, it will be understood by those skilled in the art that various changes in form and details may be made therein without departing from the spirit and scope of the invention as defined by the appended claims.

What is claimed is:

1. A method for transmitting a signal in a communication system, the method comprising the steps of:
if a traffic is generated in a power saving mode, determining whether the traffic has need for transition from the power saving mode to a normal mode;
if the traffic has need for the transition, transitioning from the power saving mode to the normal mode; and
transmitting the traffic to a corresponding destination in the normal mode.

2. The method of claim 1, further comprising the step of dropping the traffic if the traffic has no need for the transition.

3. The method of claim 2, wherein the step of determining whether the traffic has need for transition from the power saving mode to a normal mode comprises the step of determining that the traffic has need for the transition from the power saving mode to the normal mode, if the traffic meets a predetermined filtering condition.

4. A method for transmitting a signal in a communication system, the method comprising the steps of:
upon transition to a power saving mode, sending, by a lower layer unit, a notification indicating the transition to the power saving mode to an upper layer unit;
upon receipt of the notification indicating the transition, activating, by the upper layer unit, a traffic filter having a filtering condition;
if an upper layer traffic is generated after activating the traffic filter, filtering, by the upper layer unit, the upper layer traffic using the traffic filter; and
processing, by the upper layer unit, the upper layer traffic according to the filtering result.

5. The method of claim 4, wherein the step of processing, by the upper layer unit, the upper layer traffic according to the filtering result comprises the steps of:
determining by the upper layer unit whether the upper layer traffic has need for transition from the power saving mode to a normal mode; and
if the upper layer traffic has need for the transition, delivering, by the upper layer unit, the upper layer traffic to the lower layer unit, and allowing the lower layer unit to transition from the power saving mode to the normal mode and transmit the upper layer traffic to a corresponding destination.

6. The method of claim 5, further comprising the step of dropping, by the upper layer unit, the upper layer traffic if the upper layer traffic has no need for the transition.

7. The method of claim 6, wherein the step of determining whether the upper layer traffic has need for transition from the power saving mode to a normal mode comprises the step of determining that the upper layer traffic has need for the transition from the power saving mode to the normal mode, if the upper layer traffic meets a predetermined filtering condition.

8. An apparatus for transmitting a signal in a communication system, the apparatus comprising:
a subscriber station comprising;
if a traffic is generated in a power saving mode, determining whether the traffic has need for transition from the power saving mode to a normal mode;
, transitions from the power saving mode to the normal mode; if the traffic has need for the transition and
transmitting the traffic to a corresponding destination in the normal mode.

9. The apparatus of claim 8, wherein the subscriber station drops the traffic if the traffic has no need for the transition.

10. The apparatus of claim 9, wherein the subscriber station determines that the traffic has need for the transition from the power saving mode to the normal mode, if the traffic meets a predetermined filtering condition.

11. An apparatus for transmitting a signal in a communication system, the apparatus comprising:
a lower layer unit for, upon transition to a power saving mode, sending a notification indicating the transition to the power saving mode to an upper layer unit;
the upper layer unit for, upon receipt of the notification indicating the transition from the lower layer unit, activating a traffic filter having a filtering condition, filtering, if an upper layer traffic is generated, the upper layer traffic using the traffic filter, and processing the upper layer traffic according to the filtering result.

12. The apparatus of claim 11, wherein the upper layer unit determines whether the upper layer traffic has need for transition from the power saving mode to a normal mode, and if the upper layer traffic has need for the transition, the upper layer unit delivers the upper layer traffic to the lower layer unit, and allows the lower layer unit to transition from the power saving mode to the normal mode and transmit the upper layer traffic to a corresponding destination.

13. The apparatus of claim 12, wherein the upper layer unit drops the upper layer traffic if the upper layer traffic has no need for the transition.

14. The apparatus of claim 13, wherein the upper layer unit determines that the upper layer traffic has need for the transition from the power saving mode to the normal mode, if the upper layer traffic meets a predetermined filtering condition.
